(19) United States
(12) Patent Application Publication
(10) Pub. No.: US 2002/0184350 A1
(43) Pub. Date: Dec. 5, 2002

(54) Method for updating firmware by e-mail

(76) Inventor: Ko-Meng Chen, Miao Li Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/873,179

(22) Filed: Jun. 5, 2001

(51) Int. Cl. G06F 15/177

(52) U.S. Cl. 709/221; 709/220

(57) ABSTRACT

A method for updating firmware of an information apparatus by e-mail is proposed. The computer vendor for the information apparatus prepares an update program and attaches the update program to e-mail sent to the information apparatus to be updated. The content of the e-mail is discriminated if the update mode of the information apparatus is in enabled. The attached file is examined after the e-mail is received and the attached file executes update operation if the examination is correct.

### FIELD OF THE INVENTION

The present invention relates to a method for updating firmware by e-mail, especially to a method for updating firmware of an information apparatus by e-mail, which does not involves the I/O port of computer and is suitable for information appliance.

### BACKGROUND OF THE INVENTION

As the fast development of Internet, the update of firmware or software for a computer can be executed by downloading updating version thereof through FTP. However, the download of updating firmware or software is executed manually, the operation is cumbersome and sometimes the program of correct version is hard to find.

As to the update of information apparatus such as FAX or printer, the information apparatus are firstly connected to the I/O port (such as COM port or parallel port) of the computer. Then an update program is executed by computer and update data is sent to the information apparatus through packet transmission. After the information apparatus examine the validity and integrity of the update data, the information apparatus are updated by the transmitted data. The update operation is also manually executed even though the information apparatus themselves are directly connected to Internet.

### SUMMARY OF THE INVENTION

It is the object of the present invention to provide a method for updating firmware of an information apparatus by e-mail, which does not involves the I/O port of computer and is suitable for information appliance.

To achieve above object, the present invention provides a method for updating firmware of an information apparatus by e-mail. The computer vendor for the information apparatus prepares an update program and attaches the update program to e-mail sent to the information apparatus to be updated. The MIME format of the e-mail is discriminated if the update mode of the information apparatus is in enabled. The attached file is examined after the e-mail is received and the attached file executes update operation if the examination is correct.

The various objects and advantages of the present invention will be more readily understood from the following detailed description when read in conjunction with the appended drawing, in which:

### BRIEF DESCRIPTION OF THE DRAWING

FIG. 1 shows the flowchart of the method of the present invention.

### DETAILED DESCRIPTION OF THE INVENTION

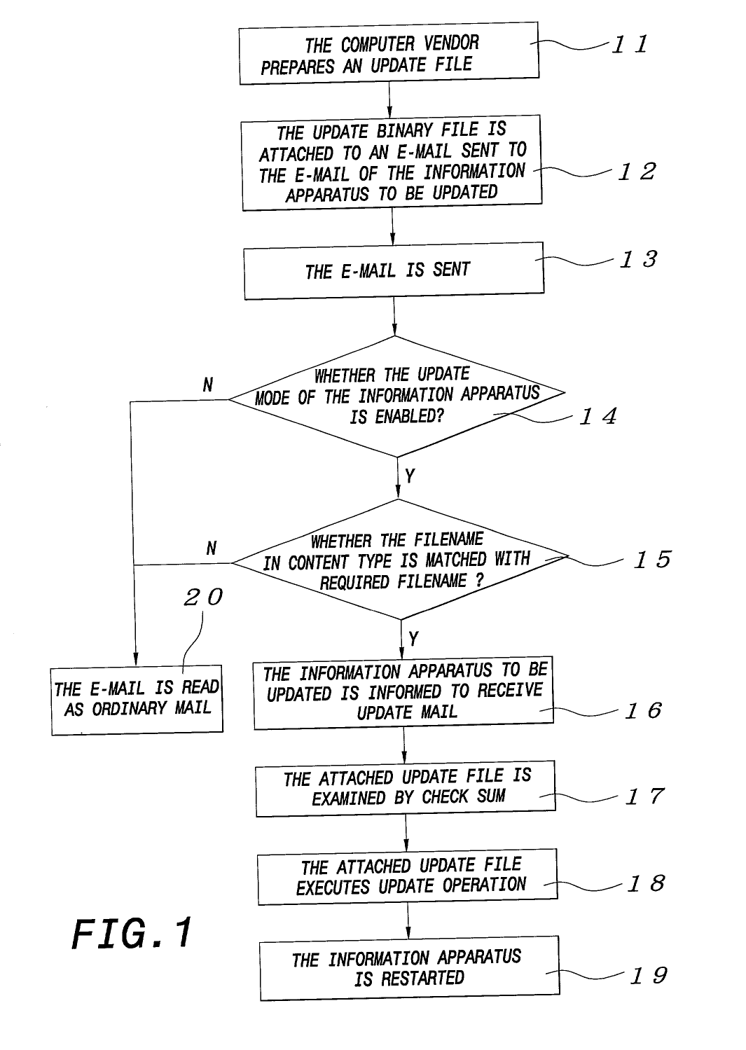

MIME (multipurpose internet mail extension) is an Internet protocol for encoding e-mail, by which, files of various formats such as audio data, video data, image data or text can be transmitted through communication protocol such as TCP/IP. The e-mail software supporting MIME function can automatically discriminate e-mail attached with MIME-type file. The present invention uses e-mail attached with MIME-type file for automatically updating firmware. As shown in FIG. 1, the method according to the present invention comprises following steps:

Step 11: The computer vendor prepares an update binary file and stores the update binary file with name associated with the information apparatus, for example, stores the update binary file with name of upgrade2100v066.bin.

Step 12: The update binary file is attached to an e-mail sent to the e-mail of the information apparatus to be updated.

Step 13: The e-mail is sent.

Step 14: Whether the update mode of the information apparatus to be updated is enabled?

if false, advancing to step 20;

if true, going to step 15.

Step 15: Whether the filename in content type of MIME format is matched with the file required for update (for example, the program name pgrade2100v066.bin shown in Table 1 is matched with pgrade2100xxxx.bin)?

if false, advancing to step 20;

if true, going to step 16.

Step 16: The information apparatus to be updated is informed to receive update mail.

Step 17: The attached update file is examined by check sum.

Step 18: The attached update file executes update operation if the check sum is correct.

Step 19: The information apparatus is restarted after the attached update file is completely executes.

Step 20: The e-mail is read as ordinary mail and the update procedure is ended.

The update file sent by the computer vendor is not limited to binary file and can be file of other type. The binary file can facilitate the MIME type discrimination. Moreover, the information apparatus to be updated is Fax or printed connected to Internet or a computer. In the later case, the computer is used with a suitable application program to execute update operation.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim

1. A method for updating firmware of an information apparatus by e-mail, comprising following steps:
(a) a computer vendor for the information apparatus preparing an update program;
(b) the update program is attached to an e-mail sent to the information apparatus to be updated;
(c) the content of the e-mail is discriminated if the update mode information apparatus is in enabled;
(d) if a filename in content type of the e-mail is matched with a file required for update, the information apparatus to be updated receives the e-mail;
(e) the attached file is examined after the e-mail is received;
(f) the attached file executes update operation if the examination is correct.

2. The method for updating firmware of an information apparatus by e-mail as in claim 1, wherein the update program in step (a) is stored in binary file.

3. The method for updating firmware of an information apparatus by e-mail as in claim 1, wherein in step (b) the e-mail is sent to the e-mail address of the information apparatus to be updated.

4. The method for updating firmware of an information apparatus by e-mail as in claim 1, wherein in step (a) the update program has a filename associated with the information apparatus to be updated.

5. The method for updating firmware of an information apparatus by e-mail as in claim 1, wherein in step (b) the information apparatus to be updated is connected to Internet.

6. The method for updating firmware of an information apparatus by e-mail as in claim 5, wherein in step (b) the information apparatus to be updated is a FAX or a printer.

7. The method for updating firmware of an information apparatus by e-mail as in claim 1, wherein in step (b) the information apparatus to be updated is a computer used with an application program.

8. The method for updating firmware of an information apparatus by e-mail as in claim 1, wherein in step (c), the e-mail is read as ordinary mail if the update mode information apparatus is not enabled.

9. The method for updating firmware of an information apparatus by e-mail as in claim 1, wherein in step (c), the content of the e-mail is discriminated with the content type in the MIME format thereof.

10. The method for updating firmware of an information apparatus by e-mail as in claim 1, wherein in step (e), the attached file is examined by check sum.
